(19) United States
(12) Patent Application Publication
(10) Pub. No.: US 2008/0051081 A1
(43) Pub. Date: Feb. 28, 2008

(54) PROFILE TRACKER FOR PORTABLE COMMUNICATION DEVICE

(75) Inventor: Joakim Nelson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS, Lund (SE)

(21) Appl. No.: 11/553,131

(22) Filed: Oct. 26, 2006

Related U.S. Application Data
(60) Provisional application No. 60/823,397, filed on Aug. 24, 2006.

(51) Int. Cl. H04Q 7/20

(52) U.S. Cl. 455/432.3

(57) ABSTRACT

A portable communication device is equipped with profile tracking functionality. A method of generating a profile for the user of the portable communication device includes tracking user activities and user preferences based on the user's use of the portable communication device. The tracked user activities and user preferences are indexed and a user profile is created based on the indexed user activities and user preferences. Profile tracking allows for the creation, viewing and exchange of profiles among users with similar interests.

### RELATED APPLICATION DATA

The present application claims the benefit of U.S. Provisional Application Ser. No. 60/823,397, filed Aug. 24, 2006, the disclosure of which is herein incorporated by reference in its entirety.

### TECHNICAL FIELD OF THE INVENTION

The present invention relates generally to portable communication devices, and, more particularly, to a portable communication device having user profile tracking capabilities.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text messaging capability, Internet browsing functionality, electronic mail capability, video playback capability, audio playback capability, image display capability, position sensing capability and hands-free headset interfaces.

With the rapid expansion of Internet activity, more and more people are interested in finding other people with similar values, interests and behaviors. Some websites provide users with the option of manually creating and posting user profiles including interests and favorite activities, music, food and the like

### SUMMARY

In view of the foregoing, a need exists for additional mobile data services and functionality, and application programs for providing additional mobile data services and functionality, such as a portable communication device and associated application program for providing profile tracking functionality.

One aspect of the invention relates to a method of a method of generating a profile for a user of a portable communication device. The method includes tracking user activities and user preferences based on the user's use of the portable communication device, indexing the tracked user activities and user preferences and creating a user profile based on the indexing of the tracked user activities and user preferences.

According to another aspect, the user activities include (i) places visited by the user, (ii) events attended by the user, (iii) networks to which the user has connected via the portable communication device and/or (iv) devices to which the user has connected via the portable communication device.

According to another aspect, tracking a user activity includes determining a location of an activity and a time or date of an activity.

According to another aspect, a location of an activity is determined using a position detection device coupled to the portable communication device.

According to another aspect, the position detection device is a Global Position System (GPS) receiver.

According to another aspect, the user preferences include (i) multimedia preferences, (ii) websites visited using the portable communication device and/or (iii) contacts stored within the portable communication device.

According to another aspect, the multimedia preferences include music preferences, video preferences, Internet content preferences and/or streaming media content preferences.

According to another aspect, indexing the tracked user activities and user preferences includes organizing tracked user activities based on date.

According to another aspect, indexing the tracked user activities and user preferences includes organizing tracked user activities based on location.

According to another aspect, creating a user profile includes creating a user profile based on one or more events attended by the user.

According to another aspect, creating a user profile includes creating a user profile based on categories of media content played by the user on the portable communication device.

According to another aspect, the method includes receiving a profile-access request from a remote portable communication device, and transmitting the user profile to the remote portable communication device.

According to another aspect, the method includes optionally activating a privacy feature, the privacy feature disabling tracking of user activities and user preferences.

According to another aspect, the method includes transmitting the profile to a website for access by third parties.

Another aspect of the invention relates to a program stored on a machine readable medium, the program being suitable for use in a portable communication device, wherein when the program is loaded in memory in the portable communication device and executed causes the portable communication device to track activities and preferences of a user of the portable communication device, index the tracked activities and preferences of the user and create a user profile based on the indexed activities and preferences of the user.

According to another aspect, the program causes the portable communication device to determine and record a location and a date of a user activity.

According to another aspect, the program causes the portable communication device to receive a profile-access request from a remote portable communication device, and transmit the user profile to the remote portable communication device.

According to another aspect, the program causes the portable communication device to activate a privacy feature, the privacy feature disabling tracking of user activities and user preferences.

According to another aspect, the portable communication device is a mobile phone.

Another aspect of the invention relates to a portable communication device that includes a memory and a processor that executes a program within the memory. The program causes the portable communication device to track activities and preferences of a user of the portable communication device, index the tracked activities and preferences of the user and create a user profile based on the indexed activities and preferences of the user.

Another aspect of the invention relates to a portable communication device that includes a processor that executes logic to track activities and preferences of a user of the portable communication device, index the tracked activities and preferences of the user and create a user profile based on the indexed activities and preferences of the user.

According to another aspect, the portable communication device is a mobile phone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system including a portable communication device on which aspects of the present invention are carried out;

FIG. 2 is a diagrammatic illustration of a portable communication device on which aspects of the present invention are carried out;

FIG. 3 is a flow chart or diagram representing the relevant operation of a portable communication device in accordance with an embodiment of the present invention;

FIG. 4 is a flow chart or diagram representing the relevant operation of a portable communication device in accordance with an embodiment of the present invention; and

FIG. 5 is a flow chart or diagram representing the relevant operation of a portable communication device in accordance with an embodiment of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with a profile tracking application.

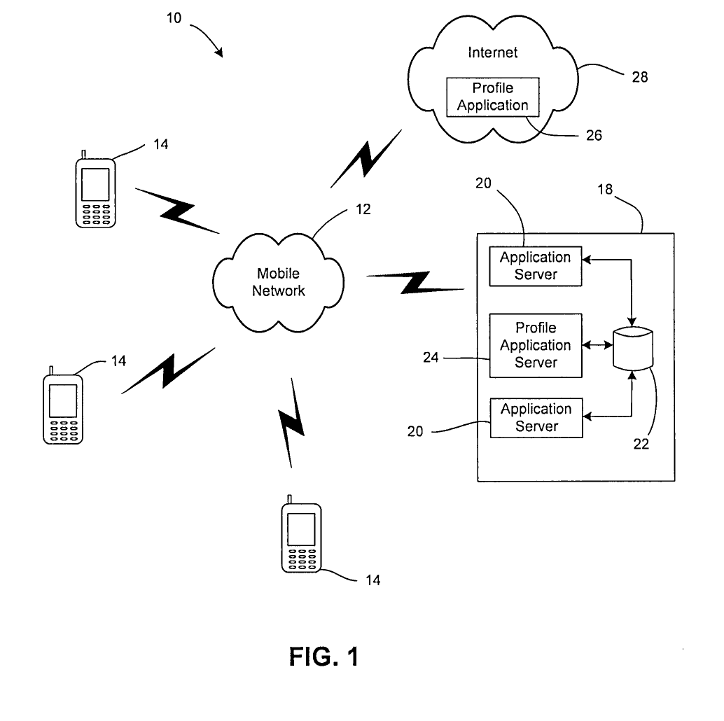

Referring initially to FIG. 1, a communication system 10 includes a mobile network 12, such as a mobile cellular telephony network, that facilitates communication, such as voice communication and/or data transfer between a plurality of portable communication devices 14, such as mobile phones, mobile terminals or the like. The communication system 10 and at least one of the portable communication devices 14 support a profile tracking application, e.g., by including appropriate hardware and/or application programs for generation and processing of a user's profile. For purposes of the discussion contained herein, portable communication device 14 will be described in terms of generating a user profile and sharing or otherwise transmitting the user profile with one or more other portable communication devices or some other remote device or system, e.g., a profile application server 26 accessible via the Internet 28.

The communication system 10 includes a network infrastructure 18, portions of which are used or otherwise accessed by the portable communication devices in connection with aspects of the invention. The portable communication devices 14 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 20. The network infrastructure 18 depicted in FIG. 1 includes a profile application server 24, e.g., an application server suitable for facilitating creation, transmission and/or receipt of a user profile for the user of a portable communication device. The application servers 20, including the profile application server 24, are computer servers that serve different functions in the communication system. As is described more fully below, one or more of the portable communication devices 14 are operable to generate, transmit and/or receive user profiles based on a user's use of his/her portable communication device.

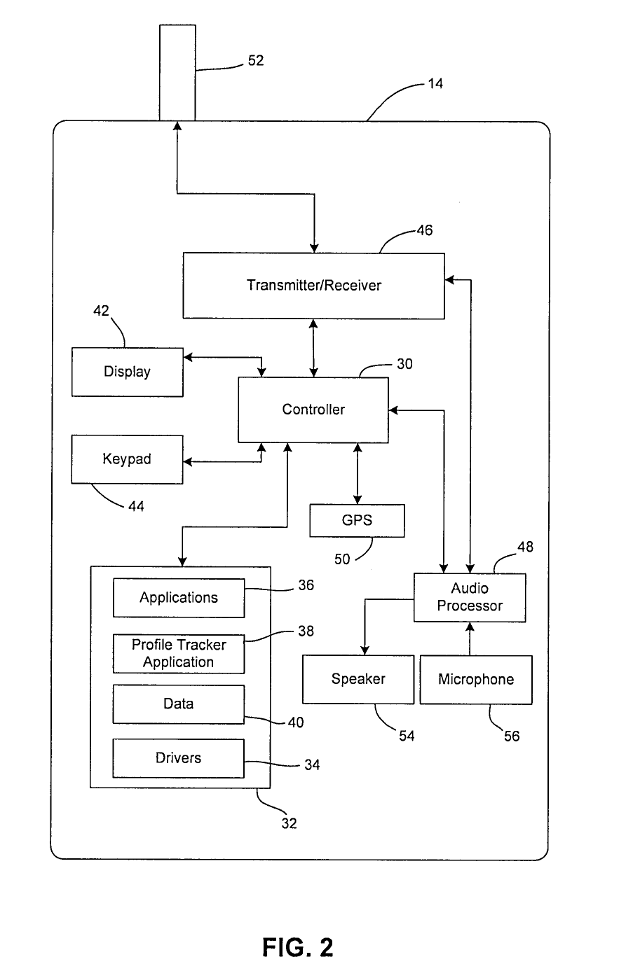

FIG. 2 represents a functional block diagram of a portable communication device 14 in accordance with aspects of the present invention. The portable communication device 14 includes a controller 30 for controlling the overall operation of the portable communication device. The controller 30 may be any commercially available or custom microprocessor. Memory 32 is operatively connected to the controller 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs 36, including a profile tracker application program 38 (also referred to as a profile tracker processor), and application program data 40. The I/O device drivers include software routines that are accessed through the controller 30 (or by an operating system (not shown) stored in memory 32) by the application programs, including the profile tracker application program 38, to communicate with devices such as the display 42 and other input/output ports.

The application programs, including the profile tracker application program 38, comprise programs that implement various features of the portable communication device 14, such as e-mail, Internet access, contact manager and the like. As is discussed more fully below, the profile tracker application program 38 comprises a program that tracks user activities and preferences and generates a user profile based on the tracked user activities and preferences, which may be shared with a remote device, e.g., another portable communication device, a remote computer via the Internet or the like.

A person having ordinary skill in the art of computer programming, and specifically in applications programming for mobile phones, will consider it obvious in view of the description provided herein how to program a mobile phone to operate and carry out the functions described herein with respect to the profile tracker application program 38 (and any interfacing between the profile tracker application program 38 and other application programs, e.g., messaging application programs, media application programs and the like). Accordingly, details as to specific programming code have been left out for the sake of brevity. Also, while the profile tracker functionality is carried out via the controller 30 and profile tracker application program 38 (alone or in conjunction with other application programs) in memory 32 in accordance with aspects of the invention, such function could also be carried out via dedicated hardware, firmware, software or combinations thereof without departing from the scope of the present invention.

With continued reference to FIG. 2, the controller 30 interfaces with the display 42, a keypad 44 (and any other user interface device), a transmitter/receiver 46 (often referred to as a transceiver), audio processing circuitry, such as an audio processor 48, e.g., an audio processing circuit, and a Global Positioning System (GPS) device 50 (optional) or other device or system for determining physical location of the portable communication device. The keypad 44 and display 42 provide a user interface that allows the user to interact with the portable communication device. Keypad 44 allows the user to dial numbers, enter commands and data, and select options. The display 42 allows the user to view a variety of information, such as dialed digits, stored information, and output from various applications, including the profile tracker application program 38.

An antenna 52 is coupled to the transmitter/receiver 46 such that the transmitter/receiver 46 transmits and receives signals via the antenna 52, as is conventional. The portable communication device 14 includes an audio processing circuit 48 for processing the audio signal transmitted by and received from the transmitter/receiver 46. Coupled to the audio processing circuit 48 are a speaker 54 and microphone 56, which enable a user to listen and speak via the portable communication device. The optional GPS 50 is operable to provide location information for the portable communication device 14. As is described below, location information provided by the GPS may be useful in connection with generating a profile for the user of the portable communication device, e.g., by providing location information for places visited by the user and/or events attended by the user.

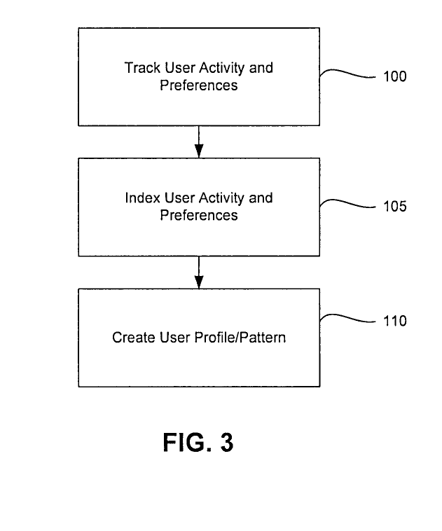

While for purposes of simplicity of explanation, the flow charts or diagrams in FIGS. 3-5 include a series of steps or functional blocks that represent one or more aspects of the relevant operation of the portable communication device 14, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

Turning now to FIG. 3, a method of generating a profile for a user of a portable communication device begins at functional block 100 where the portable communication device tracks user activity and user preferences. As is described more fully below, user activities may include, but are not limited to, messages sent, places or locations visited, events attended, devices and/or networks to which the portable communication device connects, specific dates for activities and the like. In addition, user preferences may include, but are not limited to, websites visited by the user of the portable communication device, e.g., using the portable communication device to access the Internet, contacts, e.g., phone contacts, mail contacts and the like, stored within the user preferences portion of the portable communication device, music played through or otherwise stored on the portable communication device, pod cast stations, portable recording device settings, e.g., TiVo® settings, Internet content preferences, streaming media content preferences and the like. It will be appreciated that aspects of the invention are not limited to a certain number or nature of user activities and/or user preferences tracked by the portable communication device. Moreover, as portable communication devices continue to evolve in terms of functionality and memory capacity, more and more user activities and user preferences may be tracked and incorporated into a user profile. As is discussed below, the portable communication device is configured to automatically track user activities and user preferences unless a privacy feature is enabled.

The portable communication device can be equipped to obtain location information in a variety of ways. For example, location information may be determined by receipt of location data from a dedicated system, such as a global positioning satellite (GPS), Galileo satellite system or the like. Such data may be received via a suitable position receiving, e.g., GPS receiver 50. For instance, GPS coordinates may be expressed using a standard reference system. In another exemplary embodiment, the portable communication device may receive location or position data via another suitable location determination mechanism, such as one that includes accessing an identity of a communications access point, e.g., communications tower, servicing the portable communication device at the time that location information is collected. For instance, the communications tower may be part of a cellular network, e.g., a “cell” tower, that has an associated identifier, e.g., “cell ID,” and the identifier is communicated to the portable communication device. Each identifier or cell ID in a particular servicing network may be assumed to be unique, and, therefore, may by used to indicate relative proximity to a certain location. In one embodiment, the cell ID and any related radio parameters may be used to generate a coordinate value through a radio network service. For example, under global system communications (GSM) and universal mobile telecommunications system (UMTS) protocols, the position could be estimated through a mobile originated location request (MO-LR) to the network so that the portable communication device position could be estimated using the network's knowledge or tower locations and antenna directions.

At functional block 105, the portable communication device indexes or otherwise categorizes the tracked user activities and preferences. Indexing and/or categorization of user activities and preferences may be accomplished by grouping or otherwise sorting the tracked user activities and/or preferences based on one or more predefined criteria. For example, user preferences may be grouped by multimedia preferences, e.g., types or genre of music downloaded to or otherwise played through the portable communication device, video clips downloaded or otherwise played through the portable communication device, pod-cast stations or TiVo settings pre-selected on the portable communication device and the like. Other categories may include a listing or grouping of websites visited or bookmarked, devices or networks to which the portable communication device has connected or with which the portable communication device has interacted, along with the dates and times of such connection or interaction and the like. In addition, one category of user activity may be directed to places or locations visited or events attended by the user while in possession of the portable communication device. For example, a timeline may be created based on certain events, e.g., concerts attended, movies attended, landmarks or vacation destinations visited. In this exemplary embodiment, the location would be tracked using the GPS device or other device for determining the physical location of the portable communication device.

At functional block 110 a user profile or pattern is created. The user profile or pattern may include a particular pattern or grouping of preferences that is partly unique to the user of the portable communication device. While the user profile or pattern may be unique in the details incorporated into the profile and on which the profile is based, the elements of the user profile may be similar to elements of the profiles of other users. The organization of the user profile or pattern may be customized based on one or more predefined rankings set forth by the user. For example, one aspect of the profile may be directed to a timeline of specific locations visited or events attended on or near specific dates, e.g., visiting or being in New York on Sep. 11, 2001. Alternatively, the profile or pattern may be based largely on or weighted more heavily toward multimedia preferences, such as musical preferences, video clip downloads, television or movie preferences and the like. Of course, as portable communication devices continue to advance in functionality, user activities or preferences that are available or traceable via the advanced functionality may be incorporated into the user's profile, or may be used to determine the structure of weighting of the user's profile

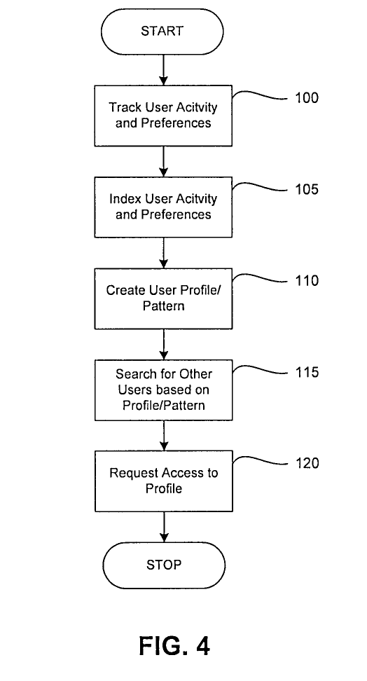

Referring now to FIG. 4, a profile tracking and sharing method begins at functional block 100 where the portable communication device tracks user activities and preferences. As is described above, user activities and/or user preferences tracked by the portable communication device may include, but are not limited to messages sent, places or locations visited, events attended, devices and/or networks to which the portable communication device connects, specific dates for activities and the like. In addition, user preferences may include, but are not limited to, websites visited by the user of the portable communication device, e.g., using the portable communication device to access the Internet, contacts, e.g., phone contacts, mail contacts and the like, stored within the user preferences portion of the portable communication device, music played through or otherwise stored on the portable communication device, pod cast stations, portable recording device settings, e.g., TiVo® and the like. At functional block 105, the tracked user activities and/or user preferences are indexed or otherwise categorized, e.g., by grouping or otherwise sorting the tracked user activities and/or preferences based on one or more predefined criteria. At functional block 110, a user profile or pattern is created or otherwise generated based on the user activities and/or user preferences. As is described more fully above, the organization of the user profile or pattern may be customized based on one or more predefined rankings set forth by the user.

At functional block 115, the user has the option to search for other individuals based on their user profile or user pattern or aspects of their user profile or pattern. Such searching can be accomplished in a number of ways without departing from the scope of the present invention. For example, a user may be able to search for others with similar user profiles or user patterns within certain proximity, e.g., by searching for other profile trackers within a given Wireless Local Area Network (WLAN) cell or via users connected to some other type of network or by sending a search query to a profile application server 24 (FIG. 1) within the communications system. Alternatively, the user may be able to conduct a search via the internet where other users have posted their profiles. In yet another exemplary embodiment, a user may be able to submit a profile search to a given profile application server. Alternatively, the portable communication device may automatically search for users whose profiles match the profile generated by the portable communication device. A user profile search may be conducted based on one of a number of parameters, including, but not limited to, users who profile is a certain percentage match with the profile of the searching user, users whose profiles contain one or more matching activity or preference categories and the like. At functional block 120, if the searching user finds one or more profiles that may be of interest to him/her, the user may request access to the profile. Of course, access may be granted or denied by the owner of the profile being requested.

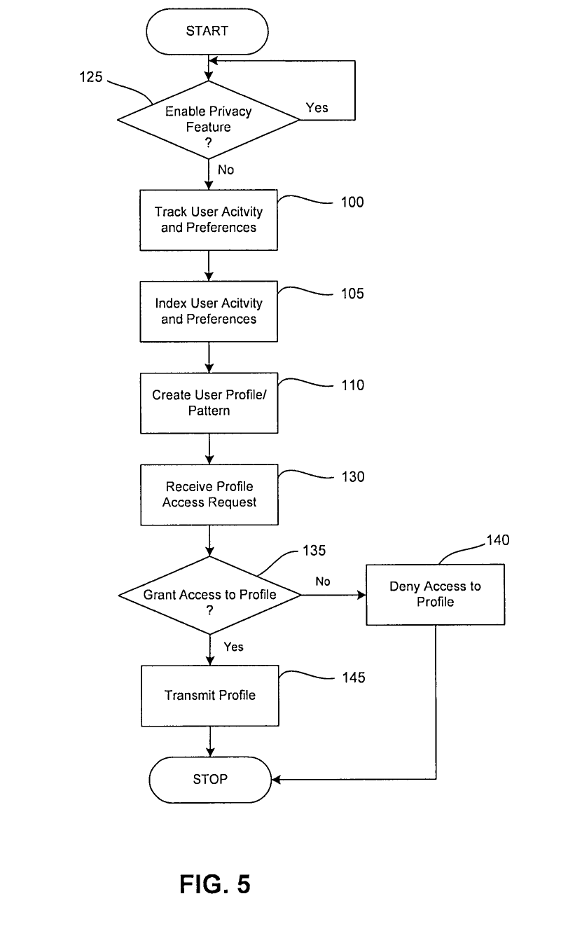

Referring now to FIG. 5, an exemplary embodiment of a method of profile tracking and sharing of user profiles is provided. The method begins at functional block 125 where the user of a portable communication device is able to enable a privacy feature. At any time during use of the portable communication device, a user may enable a privacy feature, which disables the profile tracking functionality of the portable communication device. For example, if the privacy feature is enabled, the profile tracker application program 38 (FIG. 2) will not perform any of the profile generation and tracking functionality that has been described more fully above with respect to FIG. 3 and FIG. 4. This privacy feature allows the user to enjoy the benefits of profile tracking functionality, while maintaining control over the type of information used to create the user's personal profile. Assuming that the user does not wish to enable the privacy feature, at functional blocks 100, 105 and 110 the profile tracker application will perform the profile tracking and profile creation functionality that is described more fully above, namely, tracking user activities and user preferences (functional block 100), indexing or otherwise categorizing user activities and user preferences (functional block 105) and creating or otherwise generating user profiles and/or user patterns (functional block 110). For purposes of this discussion, it is understood that functional block 100, 105 and 110 result in the creation or generation of at least one user profile for the user of a given portable communication device.

At functional block 130, the user may receive a profile access request, e.g., a request from a third party through his/her portable communication device to grant him/her access to the user's profile so that the third party may view the various specific events that are summarized or otherwise categorized by the user's profile. At functional block 135, the user is presented with the option of granting access to his/her user profile. If the user decides to deny access to his/her profile (functional block 140), e.g., if the user is not familiar with the requester of access to his/her profile, the user's portable communication device may generate an access denied message that is sent to the requesting portable communication device. At functional block 145, if the user decides to grant access to his/her profile, the portable communication device may transmit the profile (or, optionally, portions of the profile) to the requesting third-party device.

It will be appreciated that a portable communication device having profile tracking capability provides the user with the capability of tracking his/her behavior and activities, for example, in a lifetime calendar, lifetime blog or the like. Further, the creation or generation of a personal profile based on user activities and user preferences, may allow users to meet or contact people with the same or similar patterns, the same or similar interests or the same or similar behaviors. This could include people who have visited certain destinations, people who have visited a certain place at a certain time, e.g., in relation to a big event, or people that have the same taste in music, movies, literature or the like. By providing functionality within the portable communication device to keep track of a user's personal record of events and potentially match that personal record with other people, it may be possible for users to spot others with the same or similar patterns or behavior. While aspects of the invention have been described with respect to a given portable communication device requesting access to a user's personal profile, it will be appreciated that (as is illustrated in FIG. 1) users may post their profile, e.g., via a profile application or profile website on the Internet, for others to search and view. Of course, the invention as described herein is not intended to be limited to a certain methodology for requesting access, granting access or otherwise transmitting ones profile to a certain party requester. Such methodology may change as portable communication devices continue to advance in performance and functionality. These changes are contemplated within the scope of the present invention.

One of ordinary skill in the art will appreciate that the method and device described herein with reference to exemplary embodiments will lend itself of a variety of other applications that are contemplated to be within the scope of the present invention.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of generating a profile for a user of a portable communication device, the method comprising:
tracking user activities and user preferences based on the user's use of the portable communication device;
indexing the tracked user activities and user preferences; and
creating a user profile based on the indexing of the tracked user activities and user preferences.

2. The method according to claim 2, wherein the user activities include (i) places visited by the user, (ii) events attended by the user, (iii) networks to which the user has connected via the portable communication device and/or (iv) devices to which the user has connected via the portable communication device.

3. The method according to claim 1, wherein tracking a user activity includes determining a location of an activity and a time or date of an activity.

4. The method according to claim 3, wherein a location of an activity is determined using a position detection device coupled to the portable communication device.

5. The method according to claim 4, wherein the position detection device is a Global Position System (GPS) receiver.

6. The method according to claim 1, wherein the user preferences include (i) multimedia preferences, (ii) websites visited using the portable communication device and/or (iii) contacts stored within the portable communication device.

7. The method according to claim 6, wherein the multimedia preferences include music preferences, video preferences, Internet content preferences and/or streaming media content preferences.

8. The method according to claim 1, wherein indexing the tracked user activities and user preferences includes organizing tracked user activities based on date.

9. The method according to claim 1, wherein indexing the tracked user activities and user preferences includes organizing tracked user activities based on location.

10. The method according to claim 1, wherein creating a user profile includes creating a user profile based on one or more events attended by the user.

11. The method according to claim 1, wherein creating a user profile includes creating a user profile based on categories of media content played by the user on the portable communication device.

12. The method according to claim 1, further comprising:
receiving a profile-access request from a remote portable communication device; and
transmitting the user profile to the remote portable communication device.

13. The method according to claim 1, further comprising optionally activating a privacy feature, the privacy feature disabling tracking of user activities and user preferences.

14. The method according to claim 1, further comprising transmitting the profile to a website for access by third parties.

15. A program stored on a machine readable medium, the program being suitable for use in a portable communication device, wherein when the program is loaded in memory in the portable communication device and executed causes the portable communication device to:
track activities and preferences of a user of the portable communication device;
index the tracked activities and preferences of the user; and
create a user profile based on the indexed activities and preferences of the user.

16. The program according to claim 15, wherein the program causes the portable communication device to determine and record a location and a date of a user activity.

17. The program according to claim 15, wherein the program causes the portable communication device to receive a profile-access request from a remote portable communication device, and transmit the user profile to the remote portable communication device.

18. The program according to claim 15, wherein the program causes the portable communication device to activate a privacy feature, the privacy feature disabling tracking of user activities and user preferences.

19. The program according to claim 15, wherein the portable communication device is a mobile phone.

20. A portable communication device comprising a memory and a processor that executes a program according to claim 15 within the memory.

21. A portable communication device comprising a processor that executes logic to:
track activities and preferences of a user of the portable communication device;
index the tracked activities and preferences of the user; and
create a user profile based on the indexed activities and preferences of the user.

22. The portable communication device according to claim 21, wherein the portable communication device is a mobile phone.
